(19) United States
(12) Patent Application Publication
(10) Pub. No.: US 2022/0374002 A1
(43) Pub. Date: Nov. 24, 2022

(54) SELF-LEARNING MANUFACTURING SCHEDULING FOR A FLEXIBLE MANUFACTURING SYSTEM AND DEVICE

(71) Applicant: SIEMENS AKTIENGESELLSCHAFT, München (DE)

(72) Inventor: Schirin Bär, Fürth (DE)

(21) Appl. No.: 17/762,051

(22) PCT Filed: Sep. 19, 2019
(86) PCT No.: PCT/EP2019/075173

§ 371 Date: Mar. 18, 2022

(51) Int. Cl. G05B 19/418

(52) U.S. Cl. CPC G05B 19/41865; G05B 2219/31264; G05B 2219/32165; G05B 2219/32301; G05B 2219/33056

(57) ABSTRACT

A method that is used for self-learning manufacturing scheduling for a flexible manufacturing system that is used to produce at least a product is provided. The manufacturing system consists of processing entities that are interconnected through handling entities. The manufacturing scheduling will be learned by a reinforcement learning system on a model of the flexible manufacturing system. The model represents at least a behavior and a decision making of the flexible manufacturing system. The model is realized as a petri net.

An order of the processing entities and the handling entities is interchangeable, and therefore, the whole arrangement is very flexible.

This application is the National Stage of International Application No. PCT/EP2019/075173, filed Sep. 19, 2019. The entire contents of this document are hereby incorporated herein by reference.

### BACKGROUND

A flexible manufacturing system (FMS) is a manufacturing system in which there is some amount of flexibility that allows the system to react in case of changes, whether predicted or unpredicted.

Routing flexibility covers the ability of the system to be changed to produce new product types, and ability to change the order of operations executed on a part. Machine flexibility is the ability to use multiple machines to perform the same operation on a part, as well as the ability of the system to absorb large-scale changes, such as in volume, capacity, or capability.

Most FMS consist of three main systems. The work machines that are often automated CNC machines are connected by a material handling system to optimize parts flow and the central control computer that controls material movements and machine flow.

The main advantage of an FMS is high flexibility in managing manufacturing resources such as time and effort in order to manufacture a new product. The best application of an FMS is found in the production of small sets of products such as those from a mass production.

As the trend moves to modular and Flexible Manufacturing Systems (FMS), offline scheduling is no longer the only measure that enables efficient product routing. Unexpected events, such as failure of manufacturing modules, empty material stacks, or the reconfiguration of the FMS, are to be taken into consideration. Therefore, it is helpful to have an online scheduling and resource allocation system (e.g., additional online scheduling and resource allocation system).

A second problem is the high engineering effort of the decision making of a product routing system such as with classical heuristic methods. A self-learning product routing system would reduce the engineering effort, as the system learns the decision for many situations by itself in a simulation until it is applied at runtime.

Another point, which leads to high engineering effort, is to mathematically describe the rules and constraints in an FMS and to implement the rules and constraints. The idea of the self-learning agent is to understand these constraints, while the constraints are considered in the reward function in an informal way.

Manufacturing Execution Systems (MES) are used for product planning and scheduling, but it is an extreme high engineering effort to implement these mostly customer specific systems. Classical ways to solve the scheduling problem are the use of heuristic methods (e.g., meta-heuristic methods). In an unforeseen event, a reschedule is done. This is time extensive, and it is difficult to decide when a reschedule is to be done.

There are a number of concepts of self-learning product routing systems known, but with high calculation expenses, calculating the best decision online during the product is waiting for the answer.

Descriptions of those concepts may be found, for example, in the following disclosures: Di Caro, G., and Dorigo, M, “Antnet distributed stigmergic control for communications networks,” Journal of Artificial Intelligence Research, 9:317-365, 1998; Dorigo, M., and Stützle, T, “Ant Colony Optimization,” The MIT Press, 2004; Sallez, Y., Berger, T., and Trentesaux, D, “A stigmergic approach for dynamic routing of active products in fms,” Computers in Industry 60:204-216, 2009; Pach, C., Berger, T., Bonte, T., and Trentesaux, D., “Orca-fms: a dynamic architecture for the optimized and reactive control of flexible manufacturing scheduling,” Computers in Industry 65:706-720, 2014.

Another approach is a Multi Agent System where there is a central entity controlling the bidding of the agents, so the agents are to communicate with this entity, which is described in Frankovič, B., and Budinská, I, “Advantages and disadvantages of heuristic and multi agents approaches to the solution of scheduling problem,” Proceedings of the Conference IFAC Control Systems Design, Bratislava, Slovak Rep.: IFAC Proceeding Volumes 60, Issue 13, 2000, or Leitão, P. and Rodrigues, N., “Multi-agent system for on-demand production integrating production and quality control,” HoloMAS 2011, LNAI 6867: 84-93.

Reinforcement learning is a type of dynamic programming that trains algorithms using a system of reward and punishment.

Generally speaking, a reinforcement learning algorithm, or agent, learns by interacting with its environment. The agent receives rewards by performing correctly and penalties for performing incorrectly. The agent learns without intervention from a human by maximizing its reward and minimizing its penalty.

There is also work done in the field of Multi Agent Reinforcement Learning (RL) for distributed job-shop scheduling problems, where one agent controls one manufacturing module and decides whether a job may be dispatched or not.

An example is described in Gabel T., “Multi-Agent Reinforcement Learning Approaches for Distributed Job-Shop Scheduling Problems,” Dissertation, June 2009.

### SUMMARY AND DESCRIPTION

The scope of the present invention is defined solely by the appended claims and is not affected to any degree by the statements within this summary.

The disadvantage of the prior art is that a central entity is to make a global decision, and every agent only gets a reduced view of the state of the FMS, which may lead to long training phases.

The present embodiments may obviate one or more of the drawbacks or limitations in the related art. For example, a solution for the above discussed problems for product planning and scheduling of am FMS is provided.

Descriptions of the embodiments are solely examples of execution and are not meant to be restrictive for the invention.

In one embodiment, a method that is used for self-learning manufacturing scheduling for a flexible manufacturing system that is used to produce at least a product is provided. The manufacturing system consists of processing entities that are interconnected through handling entities. The manufacturing scheduling will be learned by a reinforcement learning system on a model of the flexible manufacturing system. The model represents at least a behavior and a decision making of the flexible manufacturing system. The model is realized as a petri net.

The order of the processing entities and the handling entities is interchangeable, and therefore, the whole arrangement is very flexible.

A Petri net, also known as a place/transition (PT) net, is a mathematical modeling language for the description of distributed systems. The Petri net is a class of discrete event dynamic system. A Petri net is a directed bipartite graph, in which the nodes represent transitions (e.g., events that may occur, represented by bars) and places (e.g., conditions, represented by circles). The directed arcs describe which places are pre- and/or postconditions for which transitions (e.g., signified by arrows).

There has been research done using petri nets to model the material flow, and to use the petri net model and heuristic search to schedule jobs in an FMS, for example: “Method for Flexible Manufacturing Systems Based on Timed Colored Petri Nets and Anytime Heuristic Search,” IEEE Transactions on Systems, Man, and Cybernetics: Systems 45(5):831-846, May 2015.

The present embodiments include a self-learning system for online scheduling, where RL agents are trained against a petri net until the RL agents learn the best decision from a defined set of actions for many situations within an FMS. The petri net represents system behavior and decision-making points of the FMS. The state of the petri net represents the situation in the FMS as it concerns the topology of the modules and the position and kind of the products.

The initial idea of this self-learning system is to use petri nets as a representation of the plant architecture, its state, and its behavior for training RL agents. The current state of the petri net, and therefore the plant, is used as an input for an RL agent. The petri net is also used as the simulation of the FMS (e.g., environment), as the petri net is updated after every action the RL agent chooses.

When applying the trained system, decisions may be made in near real-time during the production process, and the agents control the products through the FMS including dispatching the operations to manufacturing modules for various products using different optimization goals. The present embodiments are good in the use of manufacturing systems with routing and dispatching flexibility.

This petri net may be created manually by the user but may also be created automatically by using, for example, a GUI as depicted in FIG. 3 with a logic behind, which is able to translate the schematic depiction of the architecture in a petri net.

For every module or machine, one place is generated. For every decisions making point, there is also one place generated. For every conveyor connection between two points, there is a transition that connects the according places generated. By following these rules, the topology of the Petri net will automatically look very similar to the plant topology the user created.

The planning and scheduling part of an MES may be replaced by the online scheduling and allocation system of this present embodiments.

### BRIEF DESCRIPTION OF THE DRAWINGS

FIG. 1 illustrates a training concept of an RL agent in a virtual level (petri net) and application of the trained model at the physical level (real FMS);

FIG. 2 shows a representation of state and behavior of an FMS as a petri net to represent multiple products in the FMS (top) and a matrix that contains system behavior of the petri net (bottom); and

FIG. 3 shows a possible draft of a GUI to schematically design the FMS.

### DETAILED DESCRIPTION

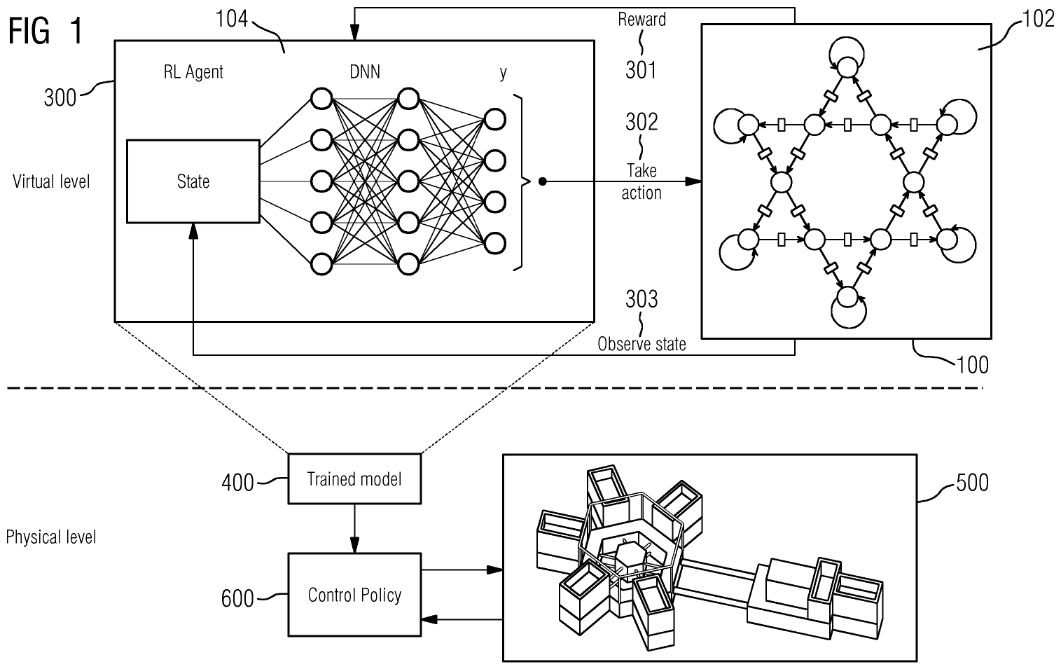

FIG. 1 shows an overview of one embodiment of a whole system from a Training system 300 with a representation of a real plant 500 as a petri net 102.

As RL technology, SARSA, DQN, etc. may be used. One RL agent model is trained against the petri net 102 to later control exactly one product. Thus, there are various agents trained for various products. In some instances, the same agent may be trained for various products (e.g., one for every product). There is no need for the products to communicate with each other, as the state of the plant includes information of a queue length of modules and a location of other products.

FIG. 1 shows the concept of training. An RL agent is trained in a virtual environment (e.g., petri net) and learns how to react in different situations. After choosing an action from a finite set of actions, beginning by making randomized choices, the environment is updated, and the RL agent observes the new state and reward as an evaluation of its action. The goal of the RL agent is to maximize the long-term discounted rewards by finding the best control policy.

During training, the RL agents sees many situations (e.g., very high state space) multiple times and may generalize for the unseen ones if neural networks are used with the RL agent. After the agent is trained against the petri net, the petri net is finetuned in the real FMS before the petri net is applied at runtime for the online scheduling.

After taking an action 302, the result in the simulation is observed 303, and feedback is given (e.g., Reward 301).

There is no need for the products to communicate with each other, as the state of the plant includes the information of the queue length of the modules and the location of the other products.

After choosing an action from a finite set of actions, beginning by making randomized choices, the environment is updated, and the RL agent observes the new state and reward as an evaluation of its action. The goal of the RL agent is to maximize the long-term discounted rewards by finding the best control policy. During training, the RL agents sees many situations (e.g., very high state space) multiple times and may generalize for the unseen ones if neural networks are used with the RL agent. After the agent is trained against the petri net, the petri net is finetuned in the real FMS before the petri net is applied at runtime for the online scheduling.

With the schematic drawing 101 of the plant and with the fixed knowledge of the meaning of the content, it is possible to automatically generate the petri 102 as schematically depicted in the figures.

In the following, the structure of the petri net 101 is explained.

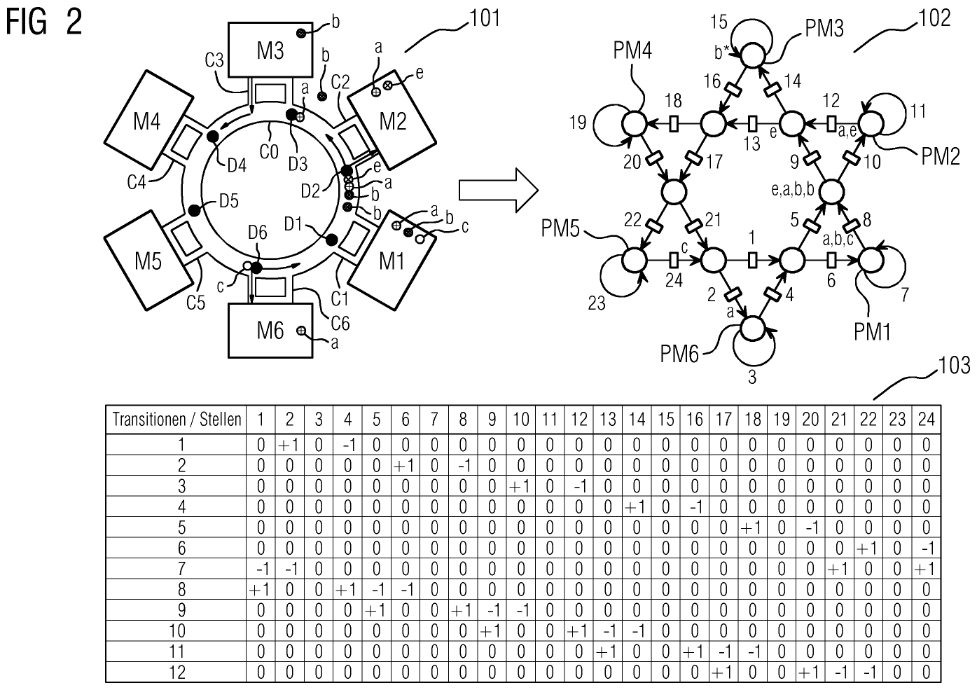

The circles are referred to as places M1, . . . M6, and the arrows 1, 2, . . . 24 are referred to as transitions in the petri net environment. The inner hexagon of the petri net in FIG. 2 represents conveyor belt sections (e.g., places 7-12), and the outer places represent places where manufacturing modules may be connected (e.g., number 1-6). Transitions 3, 11, 15, 19, 23 let the product stay at the same place. The remaining numbers 1, . . . 24 are the transitions, which may be fired to move a product (e.g., token) from one place to another place. These transitions are useful when a second operation may be executed in the same module after the first operation. The state of the petri net is defined by a product a, b, c, d, e (e.g., token) on a place. For considering many different products in an FMS, a colored petri net with the colored token as different products may be used. Instead of a color, a product ID may also be used.

The petri net, which describes the plant architecture (e.g., places) and its system behavior (e.g., transitions) may be represented in one single matrix shown also in FIG. 2 below.

This matrix describes the move of tokens from one place to another by activating transitions. The rows are the places and the columns the transitions. The +1 in the second column and first row describes, for example, that one token moves to place 1 by activating transition 2. By using a matrix as in FIG. 2, the following state of the petri net may be easily calculated by adding the dot product of the transition vector and matrix C to the previous state. The transition vector is a one-hot encoded vector, which describes the transition to be fired of the controlled agent.

The petri net representation of the FMS is a well suitable training environment for the RL agent. An RL agent is trained against the petri net, for example, by an algorithm known as Q-Learning, until the policy/Q-values (e.g., long-term discounted rewards over episode) converge. The state of the petri net is one component to represent the situation in the FMS, including the product location of the controlled and the other products, with their characteristics. This state may be expressed in a single vector and is used as one of the input vectors for the RL agent. This vector defines the state for every place in the petri net, including the type of products located on that place.

If, for example, product type a is located on place one, which has the capacity of three, the first vector entry looks as follows: [a, 0, 0].

If there is product type b and c on place two with capacity of three, the first and second vector entry look as follows: [[a, 0, 0] [b, c, 0]].

The action space of the RL agent is defined by all transitions of the petri net. So, the RL agent's task is to fire transitions depending on the state.

Transition to be fired t=(001000000000000000)

Current marking in state S1 S1=(000000010000)

Calculation of following state S2=S1+C.t

Current marking in state S2 S2=(010000000000)

The next state is then calculated very fast in a single line code and is propagated back to the reward function and the agent. The agent will first learn the plant behavior by getting rewarded negative when firing invalid transitions and will later be able to fire suitable transitions, that all the products, controlled by different agents, are produced in an efficient way. The action of the agent at runtime is translated in the direction the controlled product should go at every point a decision needs to be made. With several agents controlling different products by respective optimization goals while considering an addition global optimization goal, this system may be used as an online/reactive scheduling system.

The reward function (e.g., reward function is not part of the present embodiments; this paragraph is for understanding how the reward function is involved in training of an RL agent) values the action the agent chooses (e.g., the dispatching of a module) as well as how the agent complied with given constraints. Therefore, the reward function is to contain these process-specific constraints, local optimization goals, and global optimization goals. These goals may include makespan, processing time, material costs, production costs, energy demand, and quality.

The reward function is automatically generated, as the reward function is a mathematical formulation of optimization goals to be considered.

It is the plant operator's task to set process specific constraints and optimization goals in, for example, the GUI. It is also possible to consider combined and weighted optimization goals, depending on the plant operator's desire. In the runtime, the received reward may be compared with the expected reward for further analysis or decisions to train the model again or fine tune the model.

As modules may be replaced by various manufacturing processes, this concept is transferable to any intra-plant logistics application. The present embodiments are beneficial for online scheduling but may also be used for offline scheduling or in combination.

If in some cases there is a situation that is not known to the system (e.g., when there is a new manufacturing module), the system is able to explore the actions in this situation and learn online how the actions perform. The system thus learns the best actions for unknown situations online, though the system will likely choose suboptimal decisions in the beginning. Alternatively, there is the possibility to train the system in the training setup again with the adapted plant topology (e.g., by using the GUI).

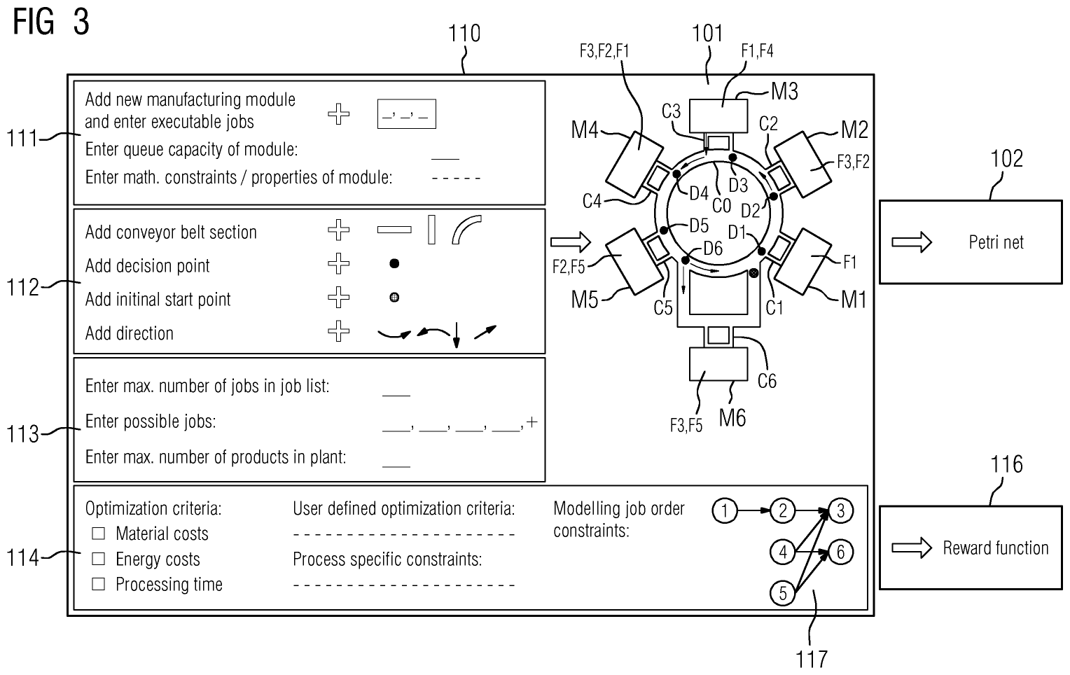

In the exemplary GUI 110 in FIG. 3, a representation of the FMS is on the right side. There are boxes M1, . . . M6 for modular and static production modules and thin boxes C, C1, . . . C6 that represent conveyor belt sections. The numbers in the modular boxes M1, . . . M6 represent the processing functionality F1, F5 of the particular manufacturing modules (e.g., drilling, shaping, printing). One task in the manufacturing process may be performed by different manufacturing stations M1, . . . M6, even if the different manufacturing stations M1, . . . M6 realize different processing functionalities that may be interchangeable.

Decision making points D1, . . . D6 are be placed at desired positions. Behind the GUI, there are fixed and generic rules implemented, such as the fact that at the decision making points, a decision is to be made (e.g., a later agent call) and the products may move on the conveyor belt from one decision making point to the next decision point or stay in the module after a decision is made. The maximum number of products in the plant, the maximum number of operations in the job-list, and job-order constraints 117 such as all possible operations, as well as the properties of the modules (e.g., including maximum capacity or queue length) may be set in the third+box 113 of the exemplary GUI. Actions may be set as well, but as default, every transition of the petri net 102 is an action.

The importance of the optimization goals may be defined 114 (e.g., by setting the values in the GUI). For example:

5×Production time, 2×quality, 1×energy efficiency

This information will then directly be translated in the mathematical description of the reward function 116, such as, for example,:

0.625 Production time+0.25×quality+0.125×time energy

The present embodiments include a scheduling system with possibility to react online to unforeseen situations very fast. Self-learning online scheduling results in less engineering effort, as this is not rule based or engineered. With the present embodiments, the optimal online schedule is found by interacting with the petri net without the need of engineering effort (e.g., defining heuristics).

The “simulation” time is really fast in comparison to known plant simulation tools because only one single equation is used for calculating the next state. No communication is needed between simulation tool and agent (e.g., the “simulation” is integrated in the agent's environment, so there is also no responding time).

No simulation tool is needed for the training.

No labelled data is needed to find the best decisions, as the scheduling system is trained against the petri net. The petri net for FMSs may be generated automatically.

Various products may be manufactured optimally in one FMS using different optimization goals at the same time and an additional global optimization goal.

Due to the RL, there is no need for an engineer to overthink every exotic situation to model rules for the system.

The decision making of the applied system takes place online and in near real-time Online training is possible, and retraining of the agents offline (e.g., for a new topology) is also possible.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for self-learning manufacturing scheduling for a flexible manufacturing system that is used to produce at least a product, wherein the flexible manufacturing system includes processing entities that are interconnected through handling entities, the method comprising:
learning, by a reinforcement learning system, the manufacturing scheduling based on a model of the flexible manufacturing system,
wherein the model represents at least a behavior and a decision making of the flexible manufacturing system, and
wherein the model is realized as a petri net.

2. The method of claim 1, wherein one state of the petri net represents one situation in the flexible manufacturing system.

3. The method of claim 1, wherein a place of the petri net represents a state of one of the processing entities and a transition of the petri net represents one of the handling entities.

4. The method of claim 1, wherein a transition of the petri net corresponds to an action of the flexible manufacturing system.

5. The method of claim 1, wherein the flexible manufacturing system has a known topology, and
wherein the method further comprises generating a matrix that corresponds to information from the petri net, the information from the petri net including information about transitions and places, and a position of the information in the matrix is ordered according to the known topology of the flexible manufacturing system.

6. The method of claim 5, wherein a body of the matrix includes an input for every product that is located in the flexible manufacturing system at one point of time, and
wherein the matrix shows a position or a move from one position to another position of the respective product in the flexible manufacturing system.

7. The method of claim 6, wherein a colored petri net is used to represent characteristics of the respective product.

8. The method of claim 5, further comprising training the reinforcement learning system using the information included in the matrix, the training comprising calculating a vector that is used as input information for the reinforcement learning system as a basis for choosing a transition to a next step of the reinforcement learning system based on additionally entered and prioritized optimization criteria regarding the manufacturing process of the product or an efficiency of the flexible manufacturing system.

9. A reinforcement learning system for self-learning manufacturing scheduling for a flexible manufacturing system that is used to produce at least a product, wherein the flexible manufacturing system includes processing entities that are interconnected through handling entities, the reinforcement learning system comprising:
a processor configured to:
learn the manufacturing scheduling based on an input to a learning process, the input including a model of the flexible manufacturing system,
wherein the model represents at least a behavior and a decision making of the flexible manufacturing system, and
wherein the model is realized as a petri net.

10. The reinforcement learning system of claim 9, wherein one state of the petri net represents one situation in the flexible manufacturing system.

11. The reinforcement learning system of claim 9, wherein a place of the petri net represents a state of one of the processing entities, and a transition of the petri net represents one of the handling entities.

12. The reinforcement learning system of claim 9, wherein a transition of the petri net corresponds to an action of the flexible manufacturing system.

13. The reinforcement learning system of claim 9, wherein the flexible manufacturing system has a known topology, and
wherein the processor is further configured to generate a matrix that corresponds to information from the petri net, the information from the petri net including information about transitions and places, and a position of the information in the matrix is ordered according to the known topology of the flexible manufacturing system.

14. The reinforcement learning system of claim 13, wherein a body of the matrix includes an input for every product that is located in the flexible manufacturing system at one point of time, and
wherein the matrix shows a position or a move from one position to another position of the respective product in the flexible manufacturing system.

15. The reinforcement learning system of claim 14, wherein a colored petri net is used to represent characteristics of the respective product.

16. The method of claim 13, wherein the processor is further configured to train the reinforcement learning system using the information included in the matrix, the training comprising calculation of a vector that is used as input information for the reinforcement learning system as a basis for choosing a transition to a next step of the reinforcement learning system based on additionally entered and prioritized optimization criteria regarding the manufacturing process of the product or an efficiency of the flexible manufacturing system.
